(19) United States
(12) Patent Application Publication
(10) Pub. No.: US 2009/0051799 A1
(43) Pub. Date: Feb. 26, 2009

(54) IMAGE PICKUP DEVICE AND IMAGE PICKUP APPARATUS

(76) Inventor: Mamoru IESAKA, Kurokawa-gun (JP)

Correspondence Address: BIRCH STEWART KOLASCH & BIRCH, PO BOX 747, FALLS CHURCH, VA, 22040-0747, US

(21) Appl. No.: 12/189,985

(22) Filed: Aug. 12, 2008

(30) Foreign Application Priority Data
Aug. 14, 2007 (JP) P2007-211371

(51) Int. Cl. H04N 5/335

(52) U.S. Cl. 348/311; 348/E05.091

(57) ABSTRACT

An image pickup device includes: a plurality of photoelectric converting portions that are arranged at predetermined intervals in horizontal and vertical directions of an imaging region, and that generate signal charges corresponding to incident light; a vertical charge transfer portion that transfers the signal charges generated in the photoelectric converting portions, in the vertical direction for each column; two horizontal transfer portions that are extended in the horizontal direction, and that transfer the signal charges transferred from the vertical charge transfer portion, in the horizontal direction; and a connecting portion that is disposed on a line connecting the two horizontal transfer portions, and between the two horizontal transfer portions, accumulates the signal charges transferred from each of the two horizontal transfer portions, and transfers the signal charges to an output amplifier.

### BACKGROUND OF THE INVENTION

1. Field of the Invention

The present invention relates to an image pickup device, and more particularly to an image pickup device in which signal charges generated in plural photoelectric converting portions arranged in horizontal and vertical directions with respect to an imaging region are transferred by a vertical charge transfer portion for each column of the photoelectric converting portions, and the signal charges transferred from the vertical charge transfer portion are transferred in the horizontal direction by a horizontal charge transfer portion, and also to an image pickup apparatus comprising such an image pickup device.

2. Background Art

In a digital camera or digital video camera which is recently in high demand, an image pickup device such as a solid-state image pickup device (CCD) is used. In order to enhance the resolution of imaging, improvement of such an image pickup device is being advanced.

In a solid-state image pickup device, plural photoelectric converting portions which produce signal charges in accordance with incident light are arranged in horizontal and vertical directions of an imaging region. Such a device includes: vertical charge transfer paths which transfer signal charges generated in the photoelectric converting portions of respective columns, in the vertical direction; and a horizontal transfer path which transfers signal charges transferred from the vertical charge transfer paths, to an output portion.

Conventionally, when the resolution of an image pickup device is enhanced, the time required for reading an image signal in an imaging process is prolonged. Therefore, Patent Reference below proposes an image pickup device in which an imaging region is divided into plural blocks, horizontal transfer portions are disposed for the divided blocks, respectively, and signal charges are transferred and output by the respective horizontal transfer portions (for example, JP-A-2004-80286 (the term “JP-A” as used herein means an “unexamined published Japanese patent application”)).

FIG. 7 is a diagram illustrating the configuration of a horizontal charge transfer portion of the conventional solid-state image pickup device. In a configuration where an imaging region is divided into plural blocks and signal charges are output, as shown in FIG. 7, horizontal transfer portions 105R, 105L are disposed vertically below the divided blocks, respectively. In a configuration where an imaging region is divided into two blocks in the horizontal direction, a horizontal transfer portion 105R which transfers signal charges of the right one of the divided blocks, and a horizontal transfer portion 105L which transfers signal charges of the left block are disposed. The horizontal transfer portions 105R, 105L transfer signal charges in opposite horizontal directions, respectively, and toward the region between the horizontal transfer portions 105R, 105L. In the middle region between the horizontal transfer portions 105R, 105L, disposed are a multiplexer portion M1 which is connected with both of the horizontal transfer portions 105R, 105L, and which can temporarily accumulate signal charges, an output gate 102 which reads out signal charges accumulated in the multiplexer portion M1, and an amplifier portion A which supplies signal charges read out from the output gate 102 to an output terminal OS. Signal charge transfer paths are formed so that the middle-side end portions of the horizontal transfer portions 105R, 105L are bent substantially perpendicularly toward the multiplexer portion M1. Between the horizontal transfer portions 105R, 105L and the multiplexer portion M1, transfer electrodes 106R, 106L which are extended respectively from the end portions of the horizontal transfer portions 105R, 105L are juxtaposed in the horizontal direction, and electrically connected to the multiplexer portion M1.

The image pickup device configuration shown in FIG. 7 has a problem in that a large area cannot be ensured between the horizontal transfer portions 105R, 105L. Specifically, transfer electrodes constituting the horizontal transfer portions 105R, 105L have a vertical dimension L of about 40 μm, and the horizontal dimension P of a region forming the multiplexer portion M1 is substantially equal to the pitch width of pixels formed in the imaging region, and usually as small as about 2 to 4 μm. In the case where the horizontal transfer electrodes 106R, 106L extended from the horizontal transfer portions 105R, 105L are to be formed between the middle-side end portions of the horizontal transfer portions 105R, 105L and the multiplexer portion M1, therefore, it is difficult to ensure a space for pattern forming. Therefore, a transfer failure, reduction of the amount of handled signal charges, and the like occur. This causes reduction of the yield of an image pickup device, or characteristic degradation.

### SUMMARY OF THE INVENTION

The invention has been conducted in view of the above-discussed circumstances. It is an object of the invention to provide an image pickup device and image pickup apparatus in which a connecting portion for electrically connecting horizontal charge transfer portions that are formed respectively for plural blocks in an imaging region, with an output portion can be easily formed, and the yield can be improved.

The object of the invention can be attained by the following configurations.

(1) According to a first aspect of the present invention, an image pickup device includes: a plurality of photoelectric converting portions that are arranged at predetermined intervals in horizontal and vertical directions of an imaging region, and that generate signal charges corresponding to incident light; a vertical charge transfer portion that transfers the signal charges generated in the photoelectric converting portions, in the vertical direction for each column; two horizontal transfer portions that are extended in the horizontal direction, and that transfer the signal charges transferred from the vertical charge transfer portion, in the horizontal direction; and a connecting portion that is disposed on a line connecting the two horizontal transfer portions, and between the two horizontal transfer portions, accumulates the signal charges transferred from each of the two horizontal transfer portions, and transfers the signal charges to an output amplifier.
(2) The image pickup device as described in the item (1), wherein the imaging region is divided in half at a substantially middle in the horizontal direction, and the two horizontal transfer portions are provided on a side where the division is made, and have end portions connected to the connecting portion.
(3) The image pickup device as described in the item (1) or (2), wherein the connecting portion is configured by plural multiplexer portions that are arranged in the vertical direction.
(4) According to a second aspect of the present invention, an image pickup apparatus comprising an image pickup device according to any one of the items (1) to (3)

In the image pickup device of the invention, two horizontal transfer portions for horizontally transferring signal charges are disposed. In the case where the imaging region is divided into two sub-imaging regions, signal charges produced in each of the sub-imaging regions are transferred by using the horizontal transfer portion corresponding to the sub-imaging region. Signal charges which are horizontally transferred by the two horizontal transfer portions are transferred to the connecting portion, and then output through the output amplifier. In the invention, the connecting portion is disposed on a line connecting the two horizontal transfer portions, and between the two horizontal transfer portions. According to the configuration, the two horizontal transfer portions can be linearly arranged through the connecting portion with respect to a substantially horizontal direction. Unlike a prior art configuration, therefore, it is not necessary to form a complicated configuration where horizontal transfer portions are vertically extended. In the image pickup device of the invention, the connecting portion can be electrically connected to the output amplifier. Therefore, the image pickup device can be easily produced as compared with the conventional configuration where, when the horizontal transfer electrodes constituting the horizontal transfer portions are pattern-formed, the end portions of the horizontal transfer portions in the transfer direction are formed by being bent perpendicularly toward the output amplifier, whereby the two horizontal transfer portions are juxtaposed in the narrow pitch between the horizontal transfer portions.

Consequently, the space can be easily ensured in production of the image pickup device, a transfer failure and reduction of the amount of handled signal charges can be prevented from occurring, and the yield of an image pickup device can be improved.

According to the invention, it is possible to provide an image pickup device and image pickup apparatus in which a connecting portion electrically connected to horizontal charge transfer portions that are formed respectively for plural blocks in an imaging region can be easily formed, and the yield can be improved.

### BRIEF DESCRIPTION OF THE DRAWINGS

The invention disclosed herein will be understood better with reference to the following drawings of which:

FIG. 1 is a diagram of an image pickup apparatus comprising the image pickup device of the invention;

FIG. 2 is a diagrammatic plan view illustrating the configuration of an image pickup device of a first embodiment;

FIG. 3 is a diagram showing the configuration of a connecting portion in the image pickup device of the first embodiment;

FIG. 4 is a timing chart of the image pickup device of the first embodiment;

FIG. 5 is a diagram showing the configuration of a connecting portion in an image pickup device of a second embodiment;

FIG. 6 is a timing chart of the image pickup device of the second embodiment; and

FIG. 7 is a diagram illustrating the configuration of a conventional image pickup device.

### DETAILED DESCRIPTION OF THE INVENTION

Hereinafter, embodiments of the invention will be described in detail with reference to the accompanying drawings.

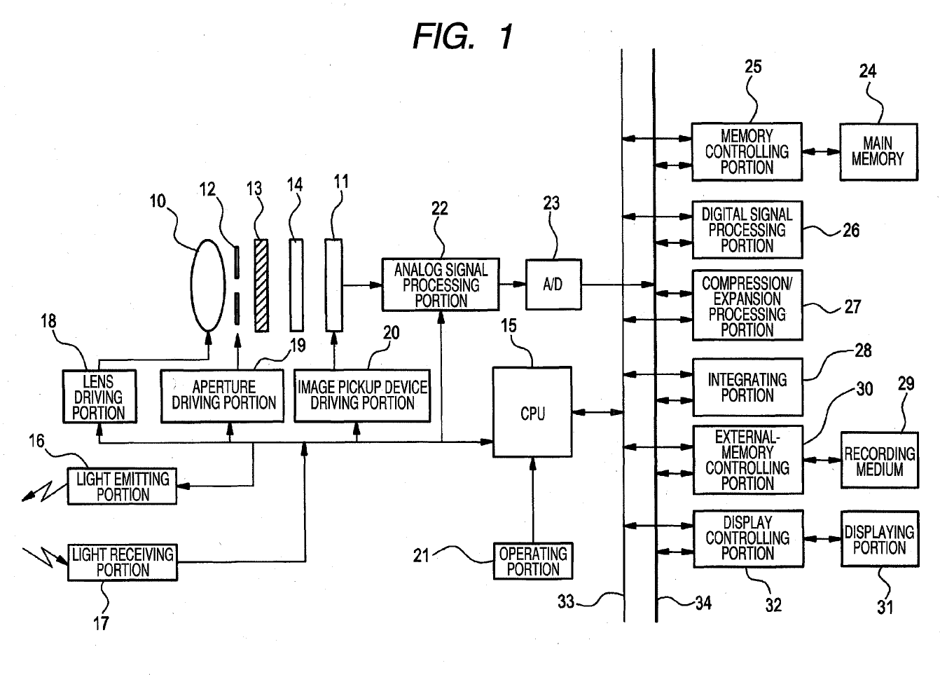

FIG. 1 is a diagram of an image pickup apparatus comprising the image pickup device of the invention. Although the embodiment will be described with exemplifying a digital still camera, the invention can be applied also to a digital camera of another kind, for example, a digital video camera or a camera mounted on a small electronic apparatus such as a portable telephone.

The digital still camera shown in FIG. 1 comprises an imaging lens 10, a CCD image pickup device 11, an aperture 12 disposed between the two components, an infrared blocking filter 13, and an optical low-pass filter 14. A CPU 15 which controls the whole digital still camera controls a light emitting portion 16 for a flash lamp and a light receiving portion 17, controls a lens driving portion 18 to adjust the position of the imaging lens 10 to the focusing position, and controls the opening degree of the aperture through an aperture driving portion 19 to adjust the exposure amount to an optimum one.

In the embodiment, color pixels which detect a signal corresponding to the amount of red (R) incident light, those which detect a signal corresponding to the amount of green (G) incident light, those which detect a signal corresponding to the amount of blue (B) incident light, and luminance detecting pixels which detect a luminance detection signal (W) are disposed in the image pickup device 11. The image pickup device 11 may be of another type such as the CMOS type, in place of the CCD type.

The CPU 15 drives the image pickup device 11 through an image pickup device driving portion 20, in the manner which will be described in detail later, and outputs an object image taken through the imaging lens 10, as a color signal. The CPU 15 receives a signal indicative of instructions from the user through an operating portion 21, and performs various controls in accordance with the instructions.

The operating portion 21 includes a shutter button. When the shutter button is in a half-depressed state (switch S1), a focus adjustment is performed, and, when the shutter button is in a fully-depressed state (switch S2), an imaging process is performed.

An electric control system of the digital still camera comprises an analog signal processing portion 22 which is connected to the output of the image pickup device 11, and an A/D converting circuit 23 which converts R, G, and B color signals and luminance detection signal Y output from the analog signal processing portion 22 to respective digital signals. These components are controlled by the CPU 15.

The electric control system of the digital still camera further comprises: a memory controlling portion 25 which is connected to a main memory (frame memory) 24; a digital signal processing portion 26 which performs a signal process that will be described in detail later; a compression/expansion processing portion 27 which compresses a taken image to a JPEG image or expands a compressed image; an integrating portion 28 which integrates photometric data to adjust the gain of white balance; an external-memory controlling portion 30 to which a detachable recording medium 29 is to be connected; and a display controlling portion 32 to which a liquid crystal displaying portion 31 mounted on, for example, the back face of the camera is connected. These portions are interconnected by a control bus 33 and a data bus 34, and controlled by instructions from the CPU 15.

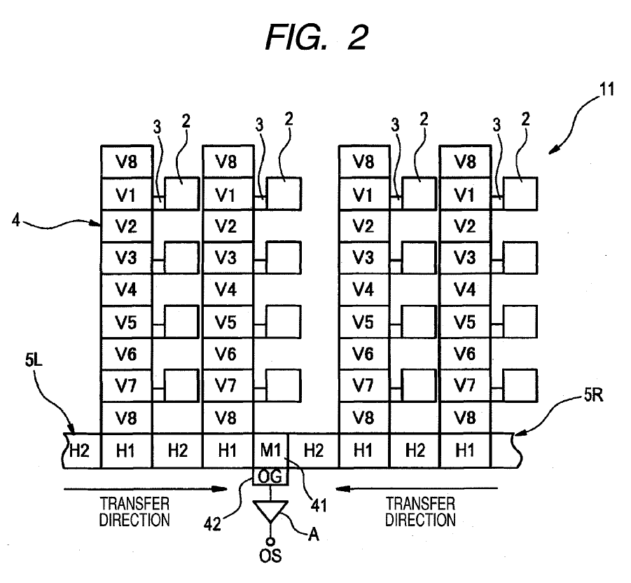

FIG. 2 is a diagrammatic plan view illustrating the configuration of a first embodiment of the image pickup device of the invention.

In the image pickup device 11, plural photoelectric converting portions 2 which are configured by, for example, photodiodes that generate a signal charge corresponding to incident light are arranged at predetermined pitches in horizontal and vertical directions of an imaging region.

Vertical charge transfer portions (VCCD) 4 which are extended in the vertical direction are formed respectively between columns of the plural photoelectric converting portions 2. Each of vertical charge transfer portions 4 has a configuration where plural vertical charge transfer electrodes V1 to V8 which are disposed in correspondence with the photoelectric converting portions 2 of each column are arranged sequentially repeatedly in the vertical direction. In the embodiment, the vertical charge transfer electrodes V1, V3, V5, V7 are connected to the corresponding photoelectric converting portions 2 through transfer gates 3, respectively.

In the image pickup device 11, when a voltage of a predetermined level is applied to the vertical charge transfer electrodes V1 to V8 of the vertical charge transfer portions 4, signal charges generated in the photoelectric converting portions 2 are read out from the photoelectric converting portions 2 to the corresponding vertical charge transfer electrodes, and then transferred in the vertical direction by the vertical charge transfer portions 4. Specifically, vertical driving signal wirings for supplying an eight-phase vertical driving signal (not shown) are connected to the vertical charge transfer electrodes V1 to V8.

Vertical end portions of the vertical charge transfer portions 4 which are located in the right side of the imaging region are electrically connected to a horizontal transfer portion 5R, and those of the vertical charge transfer portions 4 which are located in the left side of the imaging region are electrically connected to a horizontal transfer portion 5L. The horizontal transfer portions 5R, 5L are placed on a line, and have respective transfer directions which are opposite to each other. Specifically, in a charge transferring process, the horizontal transfer portion 5R transfers signal charges in the horizontal direction from the right side in FIG. 2 toward the left side, and the horizontal transfer portion 5L transfers signal charges in the horizontal direction from the left side in the figure toward the right side. In other words, the image pickup device 11 comprises a horizontal charge transfer portion (HCCD) configured by the two horizontal transfer portions 5R, 5L which transfer in the horizontal direction signal charges transferred from the vertical charge transfer portions 4, the region which is formed in the right side when the horizontal charge transfer portion is divided in two equal parts in the lateral direction (horizontal direction) in FIG. 2 corresponds to the horizontal transfer portion 5R functioning as a first horizontal CCD, and that which is formed in the left side corresponds to the horizontal transfer portion 5L functioning as a second horizontal CCD.

Each of the horizontal transfer portions 5R, 5L is configured by alternately connecting plural horizontal charge transfer electrodes H1, H2 in the horizontal direction. In the image pickup device 11 of the embodiment, when a two-phase horizontal driving signal is applied to the horizontal charge transfer electrodes H1, H2 constituting the horizontal transfer portions 5R, 5L, signal charges are transferred in the horizontal direction by the horizontal transfer portions 5R, 5L.

The image pickup device 11 of the embodiment has the configuration where the horizontal charge transfer portion is divided into the two horizontal transfer portions 5R, 5L. The horizontal transfer portions 5R, 5L are placed in correspondence with right and left subregions which are obtained by dividing the imaging region in half in the horizontal direction. A connecting portion (in FIG. 2, indicated by M1) 41 which is electrically connected to the both horizontal transfer portions 5R, 5L is disposed in end portions of the horizontal transfer portions 5R, 5L in their transfer directions.

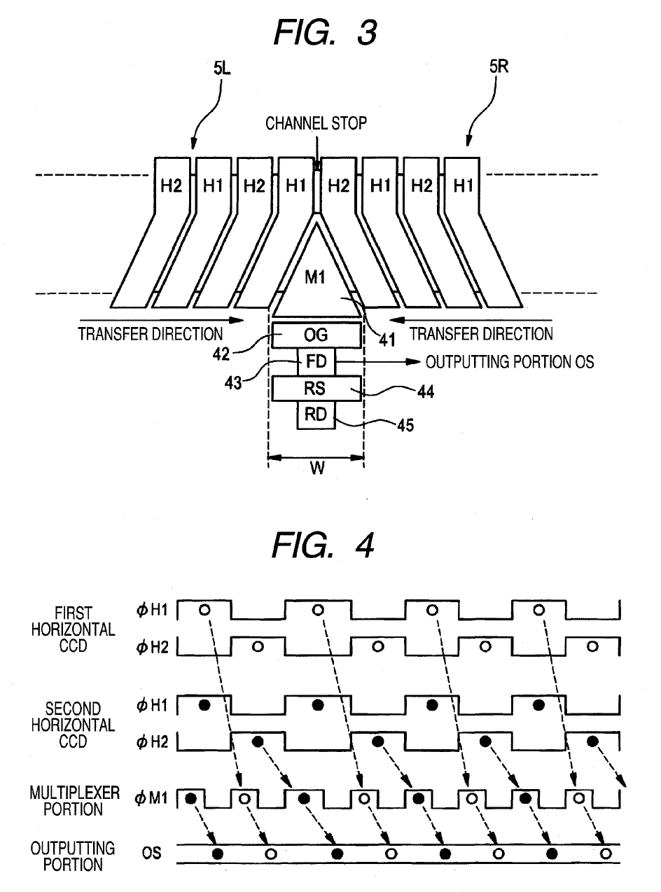

FIG. 3 is a diagram showing the configuration of the connecting portion in the image pickup device 11 of the embodiment.

An output gate (in FIG. 2, indicated by OG) 42 which reads out signal charges transferred by the two horizontal transfer portions 5R, 5L is connected to the connecting portion 41.

An output amplifier A which transfers signal charges read out by the output gate 42, to an outputting portion OS is disposed. The output amplifier A includes a floating diffusion portion (in FIG. 3, indicated by FD) 43.

A reset gate (in FIG. 3, indicated by RS) 44 to which a predetermined voltage for sweeping out unwanted signal charges remaining in the floating diffusion portion 43 is to be applied after outputting signal charges is connected to the floating diffusion portion 43. A reset drain (in FIG. 3, indicated by RD) 45 which sweeps out the swept signal charges is connected to the reset gate 44.

A channel stop which prevents signal charges from leaking is formed between the horizontal transfer portions 5R, 5L.

In the image pickup device 11 of the embodiment, the connecting portion 41 is disposed on a line connecting the two horizontal transfer portions 5R, 5L, and between the two horizontal transfer portions 5R, 5L.

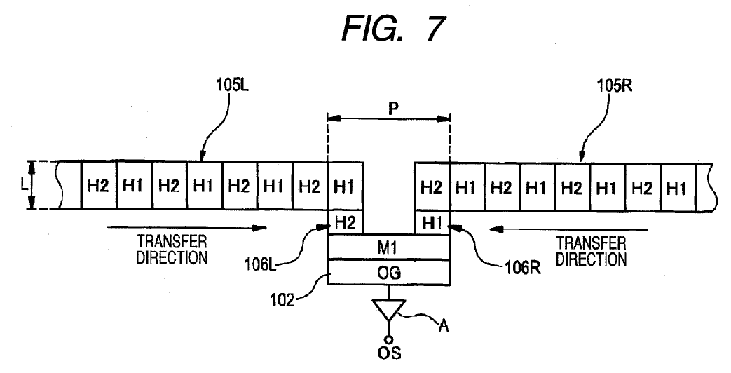

According to the configuration, it is not necessary to form a complicated configuration where, as in the conventional image pickup device shown in FIG. 7, horizontal transfer portions are vertically extended. In the image pickup device 11, the connecting portion 41 and the output amplifier A can be electrically connected to each other without extending the horizontal charge transfer electrodes H1, H2, in the pitch W defined between the two horizontal transfer portions 5R, 5L. When the horizontal transfer electrodes H1, H2 constituting the horizontal transfer portions 5R, 5L are pattern-formed, therefore, the horizontal transfer electrodes can be easily produced as compared with the conventional configuration where the end portions of the horizontal transfer portions in the transfer direction are formed by being bent perpendicularly toward the output amplifier, whereby the two horizontal transfer portions are juxtaposed in the narrow pitch between the horizontal transfer portions.

Consequently, the space can be easily ensured in production of the image pickup device, a transfer failure and reduction of the amount of handled signal charges can be prevented from occurring, and the yield of an image pickup device can be improved.

In the embodiment, the connecting portion 41 can be configured by a multiplexer portion having a mechanism which outputs plural input signals as one output signal.

FIG. 4 is a timing chart of the image pickup device of the embodiment. In FIG. 4, the horizontal transfer portions 5R, 5L are expressed as a first horizontal CCD and a second horizontal CCD, respectively, and the connecting portion 41 is expressed as a multiplexer portion. In the timing chart of FIG. 4, signal charges transferred by the first horizontal CCD are indicated by a white circle, and those transferred by the second horizontal CCD are indicated by a black circle.

As shown in FIG. 4, in a charge transferring process, transfer pulses φH1, φH2 having the same level are applied to the horizontal charge transfer electrodes H1, H2 of the first and second horizontal CCDs. When, in the first horizontal CCD, a transfer pulse of a high level is applied to the horizontal charge transfer electrode H1 adjacent to the multiplexer portion 41, signal charges are read out from the horizontal charge transfer electrode H1 to the multiplexer portion 41. By contrast, when, in the second horizontal CCD, a transfer pulse of a high level is applied to the horizontal charge transfer electrode H2 adjacent to the multiplexer portion 41, signal charges are read out from the horizontal charge transfer electrode H2 to the multiplexer portion 41.

Since the horizontal charge transfer electrodes H1, H2 perform the transferring operation by means of the two-phase driving, signal charges are read out periodically and alternately from the first and second horizontal CCDs to the multiplexer portion 41. A transfer pulse φM1 in which the period is ½ of the periods of the transfer pulses applied to the horizontal charge transfer electrodes H1, H2 is applied to the multiplexer portion 41, and signal charges are sequentially transferred to the outputting portion OS through the floating diffusion portion 43.

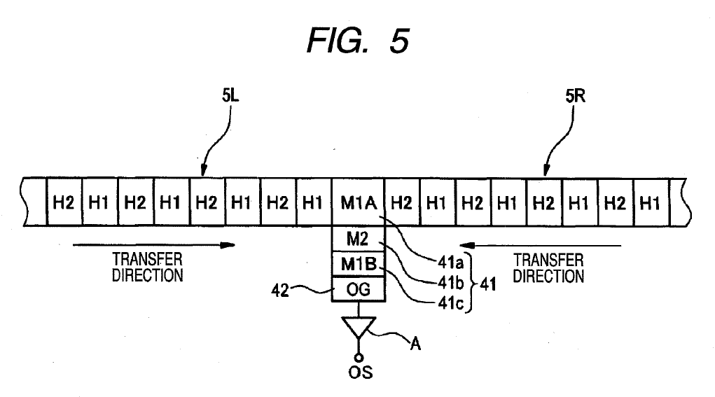

FIG. 5 shows the configuration of a second embodiment of the image pickup device of the invention. In the following description of the embodiment, members and the like which are equivalent in configuration and function to those described above are denoted by the same or corresponding reference numerals in the figure, and their description is simplified or omitted.

In the embodiment, the connecting portion 41 of the image pickup device is configured by plural multiplexer portions 41a, 41b, 41c. Specifically, the first multiplexer portion 41a is disposed on a line connecting the two horizontal transfer portions 5R, 5L, and between the two horizontal transfer portions 5R, 5L. The second multiplexer portion 41b is connected in the vertical direction to the first multiplexer portion 41a, and the third multiplexer portion 41c is connected to the second multiplexer portion 41b.

The output gate 42 is connected to the third multiplexer portion 41c, and the output amplifier A for transferring signal charges to the outputting portion OS is connected to the output gate 42.

In the embodiment, as described above, the multiplexer portions 41a, 41b, 41c are arranged in a state where the portions are electrically connected in the vertical direction. Although the embodiment has the configuration which comprises the three multiplexer portions, the number of multiplexer portions is not particularly restricted.

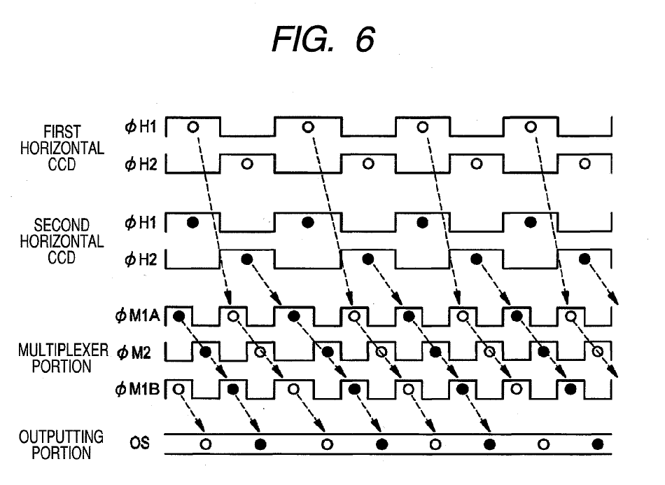

FIG. 6 is a timing chart of the image pickup device of the embodiment. In a charge transferring process, transfer pulses φH1, φH2 having the same level are applied to the horizontal charge transfer electrodes H1, H2 of the first and second horizontal CCDs. When, in the first horizontal CCD, a transfer pulse of a high level is applied to the horizontal charge transfer electrode H1 adjacent to the first multiplexer portion 41a, signal charges are read out from the horizontal charge transfer electrode H1 to the multiplexer portion 41a. By contrast, when, in the second horizontal CCD, a transfer pulse of a high level is applied to the horizontal charge transfer electrode H2 adjacent to the multiplexer portion 41a, signal charges are read out from the horizontal charge transfer electrode H2 to the multiplexer portion 41a.

Since the horizontal charge transfer electrodes H1, H2 perform the transferring operation by means of the two-phase driving, signal charges are read out periodically and alternately from the first and second horizontal CCDs to the multiplexer portion 41. Transfer pulses φM1A, φM2, φM1B in which the period is ½ of the periods of the transfer pulses applied to the horizontal charge transfer electrodes H1, H2 are applied to the multiplexer portions 41a, 41b, 41c, respectively. Signal charges in the first multiplexer portion 41a are transferred to the second multiplexer portion 41b, and further to the third multiplexer portion 41c. Signal charges in the third multiplexer portion 41c are sequentially transferred to the outputting portion OS through the floating diffusion portion 43.

According to the configuration of the embodiment, similarly with the embodiment described above, the space can be easily ensured in production of the image pickup device, a transfer failure and reduction of the amount of handled signal charges can be prevented from occurring, and the yield of an image pickup device can be improved.

In the configuration where signal charges are transferred to the outputting portion by plural multiplexer portions, in the case where the multiplexer portion is formed so as to be gradually further narrowed as more advancing toward the outputting portion, it is possible to form a shape in which the multiplexer portion is more gently narrowed than the case where the multiplexer portion is configured by a signal multiplexer portion. Therefore, the image pickup device can be produced more easily.

The present application claims foreign priority based on Japanese Patent Application (JP 2007-211371) filed Aug. 14, 2007, the contents of which is incorporated herein by reference.

What is claimed is:

1. An image pickup device comprising:
a plurality of photoelectric converting portions that are arranged at predetermined intervals in horizontal and vertical directions of an imaging region, and that generate signal charges corresponding to incident light;
a vertical charge transfer portion that transfers the signal charges generated in the photoelectric converting portions, in the vertical direction for each column;
two horizontal transfer portions that are extended in the horizontal direction, and that transfer the signal charges transferred from the vertical charge transfer portion, in the horizontal direction; and
a connecting portion that is disposed on a line connecting the two horizontal transfer portions, and between the two horizontal transfer portions, accumulates the signal charges transferred from each of the two horizontal transfer portions, and transfers the signal charges to an output amplifier.

2. The image pickup device as claimed in claim 1,
wherein
the imaging region is divided in half at a substantially middle in the horizontal direction, and
the two horizontal transfer portions are provided on a side where the division is made, and have end portions connected to the connecting portion.

3. The image pickup device as claimed in claim 1,
wherein
the connecting portion is configured by plural multiplexer portions that are arranged in the vertical direction.

4. An image pickup apparatus comprising an image pickup device according to claim 1.
